(19) United States
(12) Patent Application Publication
(10) Pub. No.: US 2010/0271642 A1
(43) Pub. Date: Oct. 28, 2010

(54) METHOD AND SYSTEM OF PRINTING USING COLOR TABLES

(76) Inventors: Xuan-Chao Huang, Lexington, KY (US); Brant Dennis Nystrom, Lexington, KY (US); Richard Lee Reel, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/428,318

(22) Filed: Apr. 22, 2009

(51) Int. Cl. H04N 1/60

(52) U.S. Cl. 358/1.9

(57) ABSTRACT

A method and system are disclosed for creating and using space-efficient color tables in an imaging system having an imaging object. The imaging object has processing conditions associated therewith, and a full size color conversion data lookup table. The color linearity of the imaging object is determined. The processing conditions of the imaging object are classified into data groups based on color linearity. A full size shared color conversion data lookup table common to the processing conditions for each of the data groups is calculated, and a small size delta color conversion data lookup table for each of the processing conditions is calculated from the differences between the full size color conversion data lookup table and the shared color conversion data lookup table. In use, the shared standard color conversion data lookup table and lo the delta color conversion data lookup table, which are stored in memory, are retrieved and used to calculate the full size standard color conversion data lookup table,

### CROSS REFERENCE TO RELATED APPLICATIONS

Cross reference is made to copending application Ser. No. 10/678,993, United States Patent Application No. 2005-0073731, (Attorney Docket No. 2008-133053).

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to an imaging system, and, more particularly, to a method and system for printing and/or copying color data in an imaging system with minimal memory usage.

2. Description of the Related Art

In recent years, the use of computers for home and business purposes has increased significantly. Computer systems typically incorporate a computer monitor, a scanner, and a printer. Users frequently employ such systems for scanning, modifying, and/or creating various color documents. The documents may include personal greeting cards, photographs, pamphlets, flyers, brochures, business presentations, business cards, and other personal or business related documents Such color documents are usually reproduced on a substrate or medium using a personal or business printer, and distributed to various recipients, such as family or friends, or individual business consumers in many different markets around the world. Typically, the printer/copier uses color tables to convert source image values to device digital counts for the ink used to produce the image on the medium. Different processing conditions relating to the substrate and the printer/copier necessitate different color tables for each printing condition.

In color printing and/or copying, the color tables are used to convert source image values to device digital counts for the ink used to produce the image on the medium. For example, the input color data from the scanner or computer may be RGB values, where R is the red color, G is the green color, and B is the blue color. The input color data must be converted into destination device digital counts, for example, CMYK values, where C is cyan ink, M is magenta ink, Y is yellow ink, and K is black ink, in order for the associated image to be printed on the medium. Generally, each medium has different processing conditions in order for the input data to be accurately printed. The different processing conditions include paper types, quality modes, color intents, e.g., graphics or image, regional preferences, e.g., North America, Europe, or Asia, printing or copying, simplex or duplex, and so on. Each processing condition requires a separate color table for accurate printing. Typically, one inkjet all-in-one (AIO) system may utilize 300 color tables to handle all the different processing conditions that it may encounter. These tables often occupy 6 megabytes of space or more, depending on how many paper types the printer/copier supports.

For standalone printing, without a computer attached, and so-called RGB-to-Box printing, where a computer sends an RGB image to the printer system, all of the color tables must be embedded in the printer system. However, the printer system has limited space, and cannot store a large number of color tables in a cost-effective way. When the printer does not have the correct color table available for printing an image, of course, a substitute color table must be used for the color conversion. Such a substitution results in a printed image that is not as accurate as desired, and the quality of the printed image suffers.

What is needed in the r is a method and system for calculating, storing and retrieving color tables that minimize the amount of storage space used so that many different paper types and conditions can be printed without adversely affecting the quality of the printed image.

### SUMMARY OF THE INVENTION

In accord with the present invention, a method of calculating space-efficient color tables in an imaging system having an imaging object, the imaging object possessing processing conditions, and a full size color conversion data lookup table associated with the imaging object includes the steps of determining the color linearity of the color data, classifying the processing conditions of the imaging object into data groups based on the color linearity of the color data, calculating a full size shared color conversion data lookup table common to the processing conditions for each of the data groups, and calculating a delta color conversion data lookup table for each of the processing conditions from the differences between the full size color conversion data lookup table and the shared color conversion data lookup table.

Further in accord with the present invention, a method for converting input color data to output color data in an imaging system having an imaging apparatus, a shared standard color conversion data lookup table and a delta color conversion data lookup table, includes the steps of retrieving the shared standard color conversion data lookup table, retrieving the delta color conversion data lookup table, calculating a full size standard color conversion data lookup table from the shared standard color conversion data lookup table and the delta color conversion data lookup table, and calculating the output color data from the full size standard color conversion lookup table and the input color data.

Still further in accord with the present invention, a system used in an imaging apparatus includes a memory storing a shared standard color conversion data lookup table and a delta color conversion data lookup table associated with the imaging apparatus. A first circuit retrieves the shared standard color conversion data lookup table and the delta color conversion data lookup table A second circuit calculates a standard color conversion data lookup table from the shared standard color conversion data lookup table and the delta color conversion data lookup table retrieved by the first circuit.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein

FIG. 1 is a diagrammatic depiction of an imaging system that utilizes the present invention.

FIG. 2 is a diagrammatic depiction of a colorspace converter according to an embodiment of the present invention.

FIGS. 3A and 3B are a flow chart of the method of the present invention.

FIGS. 4A and 4B are a flow chart of the method of the present invention for classifying processing conditions into groups.

FIGS. 5A and 51B are a flow chart of the method of the present invention for calculating a full size color conversion data lookup table and a small size delta color conversion data lookup table.

FIG. 6 is a is a flow chart of the method of the present invention for dynamically creating a full size color conversion data lookup table from the small size delta color conversion data lookup table and the full size shared color conversion data lookup table.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including, comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

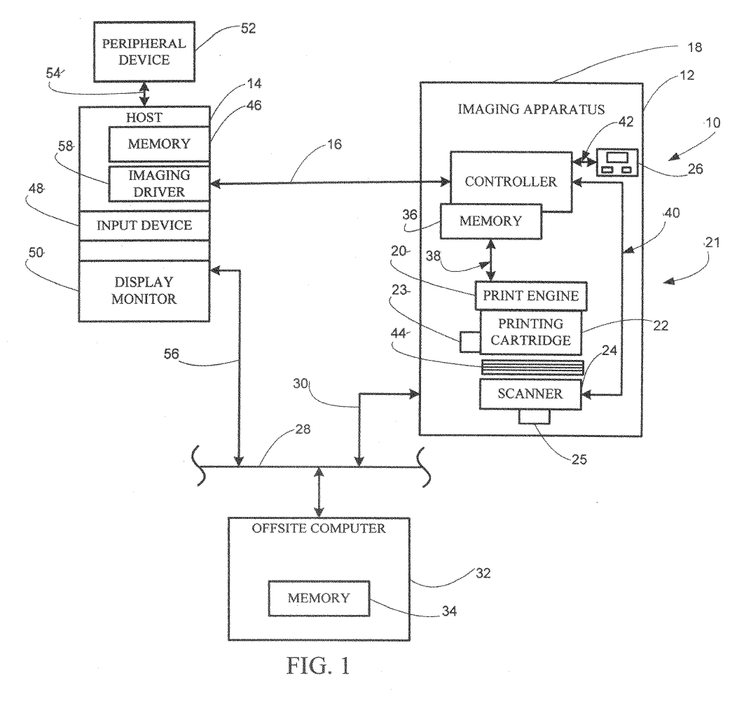

Referring now to the drawings, and particularly to FIG. 1 thereof, there is shown a diagrammatic depiction of an imaging system 10 embodying the present invention, as disclosed in application Ser. No. 10/678,993, United States Patent Application No. 2005-0073731, (Attorney Docket No. 2008-133053), incorporated herein by reference. The imaging system 10 includes an imaging apparatus 12 and a host 14. The imaging apparatus 12 communicates with the host 14 via a communications link 16.

The imaging apparatus 12 can be, for example, an ink jet printer and/or copier, an electrophotographic printer and/or copier, or an all-in-one (AIO) unit that includes a printer a scanner, and possibly a fax unit. As an AIO unit, the imaging apparatus 12 includes a controller 18, a print engine 20, and one or more of an imaging object 21, such as a printing cartridge 22 having a cartridge memory 23, and a scanner 24 having a scanner memory 25, and a user interface 26. The imaging apparatus 12 has access to a network 28, such as the Internet, via a communication line 30, to interface with an offsite computer 32 having an offsite memory 34, in order to transmit and/or receive data for use in carrying out its imaging functions.

The controller 18 includes a processor unit and an associated memory 36, and may be formed as one or more Application Specific Integrated Circuits (ASIC). The controller 18 may be a printer controller, a scanner controller, or may be a combined printer and scanner controller. The controller 18 communicates with the print engine 20 via a communications link 38, with the scanner 24 via a communications link 40, and with the user interface 26 via a communications link 42. The controller 18 serves to process print data and to operate the print engine 20 during printing.

In the context of the examples for the imaging apparatus 12 given above, the print engine 20 can be, for example, an ink jet print engine or a color electrophotographic print engine, configured for forming an image on a substrate or medium 44, such as a sheet of paper, transparency or fabric. As an ink jet print engine, the print engine 20 operates the printing cartridge 22 to eject ink droplets onto the substrate 44 in order to reproduce text or images, etc. As an electrophotographic print engine, the print engine 20 causes the printing cartridge 22 to deposit toner onto the substrate 44, which is then fused to the substrate 44 by a fuser (not shown).

The host 14 may be, for example, a personal computer, including the memory 46, an input device 48, such as a keyboard, and a display monitor 50. A peripheral device 52, such as a digital camera, is coupled to the host 14 via a communication link 54. The host 14 further includes a processor, input/output (I/O) interfaces, a memory, such as RAM, ROM, or NVRAM, and at least one mass data storage device, such as a hard drive, a CD-ROM and/or a DVD unit, and is connected to the network 28 via a communication line 56.

During operation, the host 14 includes in its memory a software program including program instructions that function as an imaging driver 58, e.g., printer/scanner driver software, for the imaging apparatus 12. The imaging driver 58 is in communication with the controller 18 of the imaging apparatus 12 via the communications link 16. The imaging driver 58 facilitates communication between the imaging apparatus 12 and the host 14, and may provide formatted print data to the imaging apparatus 12, and more particularly, to the print engine 20. Alternatively, however, all or a portion of the imaging driver 58 may be located in the controller 18 of the imaging apparatus 12.

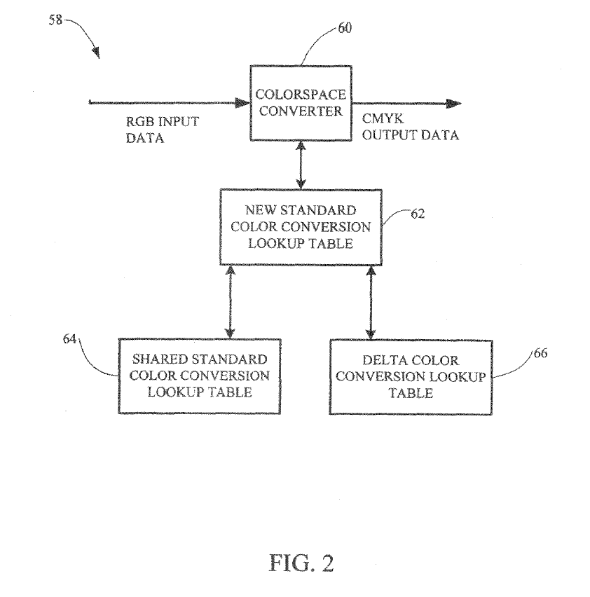

Referring now to FIG. 2, the imaging driver 58 includes a colorspace converter 60. Although described herein as residing in the imaging driver 58, the colorspace converter 60 may be in the form of firmware or software, and may reside in either the imaging driver 58 or the controller 18, for example. Alternatively, some portions of the colorspace converter 60 may reside in the imaging driver 58, while other portions may reside in the controller 18.

A new standard color conversion lookup table 62 is formed from a shared standard color conversion data lookup table 64, and a small size delta color conversion data lookup table 66. The standard color conversion data lookup table 62 is coupled to the colorspace converter 60. The colorspace converter 60 is used to convert input color data, such as color signals, of a first colorspace, such as an RGB colorspace output by the display monitor 50 or the scanner 24, to output color data of a second colorspace, for example, CMYK (cyan, magenta, yellow, and black), which is used by the print engine 20 to print an image on substrate 44.

The new standard color conversion data lookup table 62, the shared standard color conversion data lookup table 64, and the delta color conversion data lookup table 66 are multidimensional data lookup tables having at least three dimensions that include multidimensional color data, such as CMYK, CIEXYZ, CIELAB, RGB, or any other color data. For example, if the imaging object 21 is the printing cartridge 22 or the substrate 44, the new standard color conversion data lookup table 62 and the shared standard color conversion data lookup table 64 include CMYK data, CIEXYZ data or CIELAB data. If the imaging object 21 is the scanner 24, the new standard color conversion data lookup table 62, the shared standard color conversion data lookup table 64, and the delta color conversion data lookup table 66 include RGB data. The new standard color conversion data lookup table 62, the shared standard color conversion data lookup table 64, and the delta color conversion data lookup table 66 may also include additional data, such as spectral data.

Each of the new standard color conversion data lookup table 62, the shared standard color conversion data lookup table 64, and the small size delta color conversion data lookup table 66 may also be in the form of groups of polynomial functions capable of providing the same multidimensional output as if in the form of data lookup tables. In the exemplary embodiment, the new standard color conversion data lookup table 62 is the color conversion data lookup table used by the imaging apparatus 12 to print an image on substrate 44, while the shared standard color conversion data lookup table 64, and the small size delta color conversion data lookup table 66 are used to generate the new standard color conversion data lookup table 62, as discussed more fully below. As shown in FIG. 2, the colorspace converter 60 converts input RBG color data for a displayed or scanned image into CMYK output data, using the new standard color conversion data lookup table 62, which may be printed by the print engine 20.

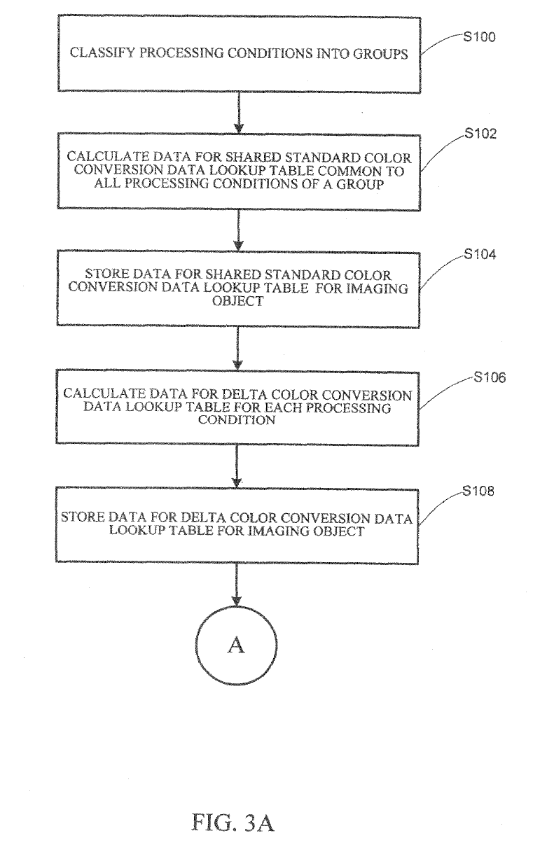

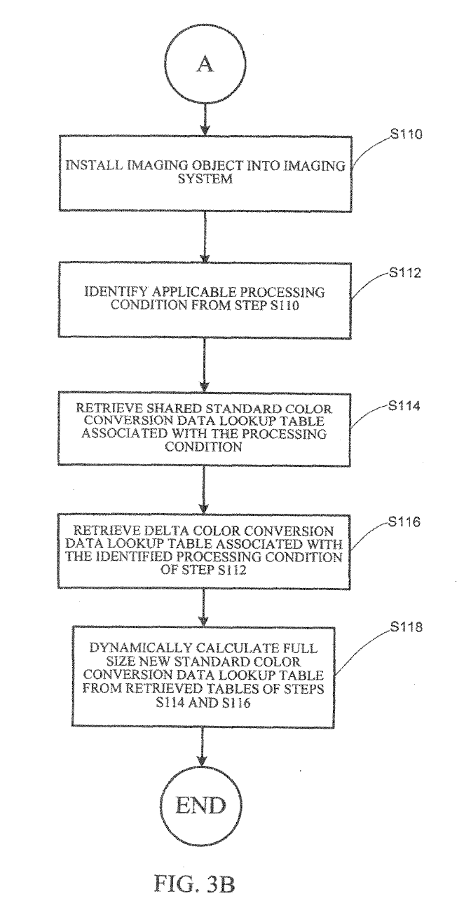

Referring now to FIG. 3, there is generally depicted a method for calculating color tables used to accommodate different processing conditions in the imaging system 10 having an imaging object 21, and having at least one new standard color conversion data lookup table 62 associated with the imaging object 21. Here, the term “imaging object,” relates to imaging components that are used by the imaging system 10 in creating, scanning, or outputting images, such as, for example, the printing cartridge 22, the scanner 24, or various substrates 44, as well as any other component of an imaging system that may be subject to replacement at the end of its useful life or when its supply is exhausted.

As noted hereinbefore, the processing conditions for printing an image on media can be conveniently classified into groups based on color linearity. Color linearity means that a linear relationship exists between ink color values, for example, L*a*b*, and the ink digital count, that is, the digital number representing how much ink must be deposited on the medium or substrate 44 for the correct color to be printed. Exemplary groups include paper types, quality modes, color intents, graphics or image, regional preferences, e.g., North America, Europe, or Asia, printing or copying, or simplex or duplex. Generally, different processing conditions require different color tables. For example, printing on glossy paper using best quality mode requires a different color table than printing on glossy paper in normal quality mode. If only one table were used for the two modes, prints made in the normal print mode would be too dark, with over-saturated colors, since the normal print mode is about twice as fast as prints made in best quality mode. The shorter ink drying time of normal print mode generally yields darker and more saturated colors as compared to prints made in best quality mode.

The color response under different ink amount mixing is non-linear, and hence, a look-up table is utilized to convert source image data into ink digital counts, i.e., how much ink must be deposited on the medium for the correct color to be printed (See FIG. 2). For each of the R, G, and B color data values in the conversion from RGB space to CMY/CMYK space, n even-spaced points are sampled. All of the combinations form (n*n*n) 3-dimensional table grids, referred to as an n-cube table. Each table grid has m digital counts. In one typical embodiment, m=3 for the CMY space and m=4 for the CMYK space. An n-cube table can also be referred to as an n-cube-m-ink table or n-cube-m-channel table. The table size is (n*n*n*m) bytes for an 8-bit representation. The more non-linear the conversion, the larger the number n is required. In one practical application, a 17-cube table (n=17) is used for the RGB to CMY/CMYK color space conversion.

Although the color response within an entire ink space is non-linear, portions of the space can be reasonably accurately approximated by a group of polynomial equations whose first derivatives are relatively linear. The differentiation of a polynomial equation is more linear than the original equation from which it is derived. For example, in the non-linear quadratic equation y=x², the first derivative is dy/dx, or 2x, which is a linear equation. When a delta or difference table of data representing first derivatives is calculated from a group of polynomial equations representing portions of the color space, the corresponding table size is smaller than the original table. It is to be appreciated that the resulting delta table of first derivatives does not degrade the quality of the color conversion. It will also be appreciated that the delta table calculated according to this method contains digital counts that are relative values, so a base table with absolute values is required for converting the relative values into absolute values for real color conversion. As explained more fully herein, the base table of the present invention is shared by a sub-set of processing conditions in order to minimize space requirements and increase processing speed.

Turning now to FIG. 3A, the method of the present invention for calculating space-efficient color tables used in a printer/copier 10 begins at step S100, where the processing conditions of the input RGB color data are classified into groups. At step S102, a shared standard color conversion data lookup table is calculated for data common to all of the processing conditions of a group. At step S104, the data for the shared standard color conversion data lookup table is stored in memory for the imaging object 21. At step S106, a small size delta color conversion data lookup table is calculated for each processing condition, and at step S108, the data from step S106 is stored in memory for the imaging object 21. The process then continues at “A” on FIG. 3B, where, at step S110, the imaging object 21 is installed in the imaging system 10. At step S112, the applicable processing condition for the imaging object of step S110 is identified. At step S114, the shared standard color conversion data lookup table 64 associated with the processing condition, and previously stored in the memory 36 at step S104, is retrieved. At step S116, the delta color conversion data lookup table 66 associated with the identified processing condition of step S112, and previously stored in the memory 36 at step S108, is retrieved. At step S118, the full size new standard color conversion data lookup table 62 is dynamically calculated from the shared standard color conversion data lookup table 64 and the delta color conversion data lookup table 66 retrieved at steps S114 and S116, respectively The full size new standard color conversion data lookup table 62 is then used by the color space converter 60 to generate the CMYK output data (see FIG. 1). After step S118, the process ends.

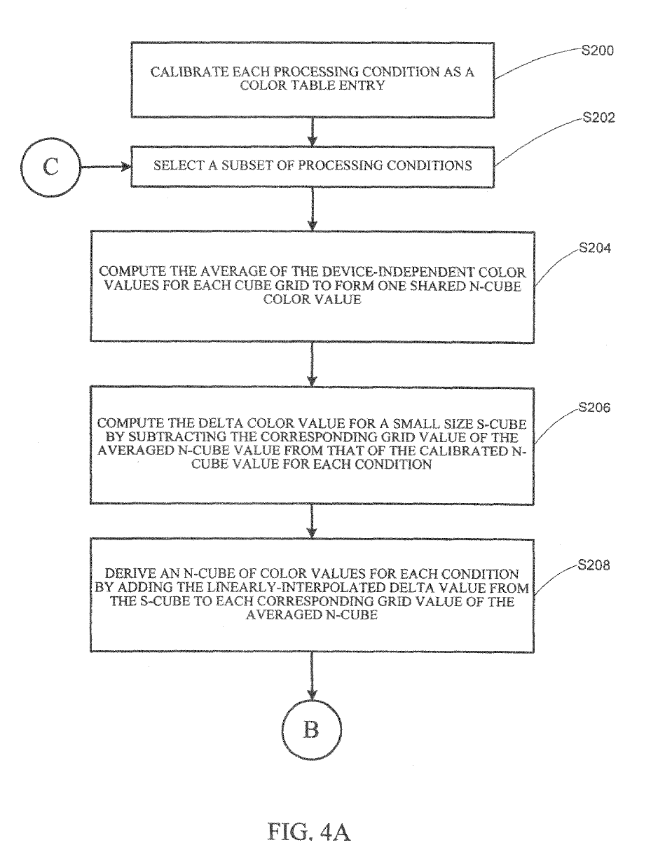

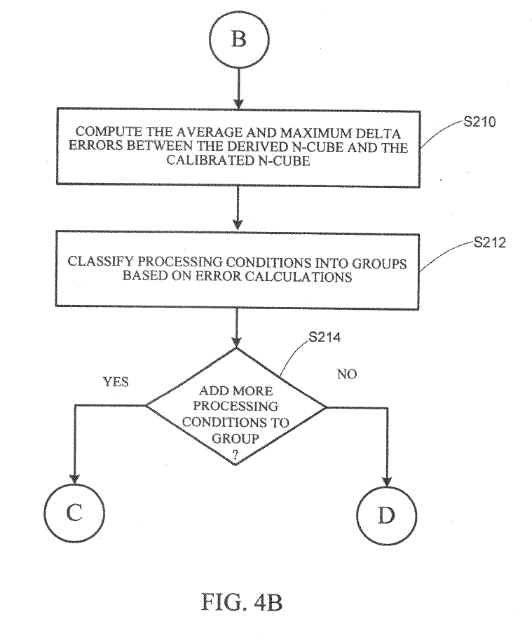

Turning now to FIG. 4A, a method of calibration for each processing condition is performed, as is known in color table calculations. At step S200, each processing condition is calibrated as a color table entry. At step S202, a subset of the processing conditions is selected, and an n-cube of a device-independent color space, such as the CIELAB color values (L*, a*, b*), is sampled for the selected condition, such as, for example, n=9.

At step S204, the average of the device-independent color values for each cube grid is computed to form one shared n-cube table of color values.

A small size s-cube, where s=(integer) ((n+1)/2), is selected for the case where s=5 and n=9. At step S206, for each of the s-cube grids, the difference or delta color values are computed. For the CIELAB space, for example, dL*, da*, db* are computed by subtracting the corresponding grid value of the averaged n-cube from that of the calibrated n-cube for each condition. The subtraction occurs only on the sub (s*s*s) grids of the original (n*n*n) grids.

At step S208, an n-cube table of color values for each condition is computed by adding the linearly interpolated delta value from the s-cube to each corresponding grid value of the averaged n-cube. The process continues at step “B” on FIG. 4B, where, at step S210, the average and maximum delta errors between the derived n-cube and the calibrated n-cube table are computed.

For each grid point of the derived n-cube and the corresponding grid point of the calibrated n-cube, the delta error is computed. In CIELAB space, for example, dL*, da*, db* are used for each of the paired grids. The delta error is then:

delta error=\sqrt{(dL*×dL*+da*×da*+db*×db*)}

In the Cartesian coordinate system, this is analogous to the distance between two points. If the two points are the same, the distance, of course, is zero. For all of the paired grids, the average delta error is computed, where:

average delta error=(sum of delta error)/(total number of the paired grids)

Then a search is performed to identify the maximum delta error. If the derived n-cube and the calibrated n-cube are the same, then the

average delta error=maximum delta error=0.

Turning now to step S212, the processing conditions are then classified into one group if the average and maximum errors are within predetermined tolerance values. In the illustrated example for the CIELAB color space, the criteria values that are used are (1) the average error is less than 1.0, and (2) the maximum error is less than 3.5.

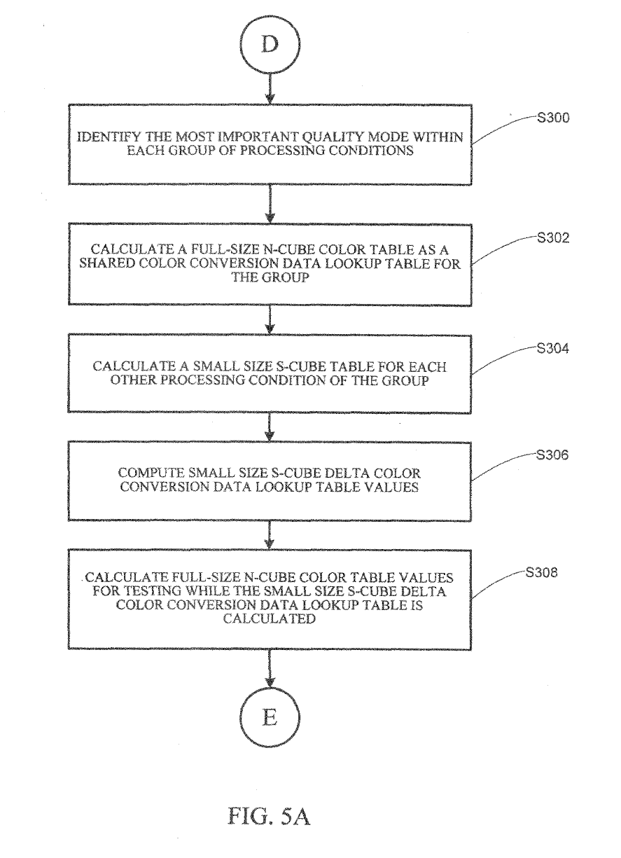

At step S214, the process tests to determine whether more processing conditions need to be added to a group. The error calculations performed at step S212 are used to make this determination. If the answer at step S214 is “Yes,” meaning that more processing conditions need to be added to the group, the process returns to step “C” on FIG. 4A for the next processing condition to be calculated by the process discussed above. If the answer at step S214 is “No,” meaning that no further processing conditions need to be added to a group, the process continues at step “D” on FIG. 5A.

Table I, below, illustrates values for the example in which glossy papers 1 and 2, and the corresponding 3 quality modes, are classified as one group. Although the color values differ between the two glossy papers, with an average error of 8.69 and a maximum error of 19.08, the small size delta table representation, combined with a shared original size table for the group, is well within acceptable tolerances. That is, the average error is less than 1.0 and the maximum error is less than 3.5.

TABLE I
Classifying processing conditions - quality modes and paper types

| | | | Delta Error between two representations | | | |
|---|---|---|---|---|---|---|
| | | | of original 9-cube CIELAB, | | | |
| | Delta Error of | | and derived 9-cube from a 5-cube | | | |
| | 9-Cube | | delta-CIELAB per mode/paper and | | | |
| | CIELAB | | a base of 9-cube CIELAB shared by | | | |
| | between two | | all of the modes and glossy papers. | | | |
| Quality | glossy papers | | Glossy paper 1 | | Glossy paper 2 | |
| Mode | Average | Max | Average | Max | Average | Max |
| Quick | 9.50 | 20.94 | 0.78 | 3.14 | 0.89 | 3.43 |
| Normal | 8.16 | 17.76 | 0.65 | 2.40 | 0.64 | 2.53 |
| Best | 8.41 | 18.53 | 0.67 | 2.43 | 0.67 | 2.83 |
| Average | 8.69 | 19.08 | 0.70 | 2.66 | 0.73 | 2.93 |

FIGS. 5A and 5B illustrate the steps for constructing a full size shared standard color conversion data lookup table and a small size delta color conversion data lookup table stored in memory. Continuing front step “D” on FIG. 4B, at step S300, the construction of the full size shared standard color conversion data lookup table 64 begins by identifying a most important quality mode within each group of processing conditions. At step S302, a full size n-cube color table is built as a shared table for the group, where n=17. The contents of the delta color conversion table 66 are all zeros at this step.

At step S304, a small size s-cube table is calculated for each of the other processing conditions of the group, where s=(integer) ((n+1)/2). The first time this step is executed, the small size s-cube is not a delta color conversion data lookup table, but an initialization condition table with initialization entries In one embodiment, s=9 for n=17. The small size s-cube table is calculated in the same way as the full size table is calculated. It will be appreciated that the size s could be smaller in different applications, depending on color non-linearity. As a general rule, the relationship between n and s is calculated by the equation

$$s = \frac{( n + {2}^{t} - 1 )}{{2}^{t}} t = 1 , 2 , 3 , … and s \geq 2$$

When n=17, s=9 for t=1, s=5 for t=2, s=3 for t=3, and s=2 for t=4. In the illustrated embodiment, s=9 for n=17 has been found to be the most appropriate. Since the number of s-cube grids (729 grids for 9-cube) is much smaller (about 15% for s=9 and n=17) than the full size n-cube grids (4913 grids for 17-cube), all of the s-cube grid colors can be printed on one page to assist a color table developer in examining the color outputs and reducing or eliminating color mapping defects.

At step S306, a small size s-cube delta table is computed. For each s-cube grid, the corresponding n-cube grid value, which has the same coordinates as the s-cube grid of the shared table, is subtracted from the s-cube grid value for each ink and is assigned as the delta value of the s-cube grid.

At step S308, a full size n-cube color table is derived for testing while the small size s-cube delta color conversion table is being calculated. For each n-cube grid, the corresponding shared n-cube grid values are calculated. A linear interpolation is performed on the small size s-cube delta table using the n-cube grid coordinates. The interpolated delta value is added to the shared table grid value and the sum is assigned to the new full size n-cube grid for each ink. The process then continues at step “E”.

FIG. 5B illustrates an alternate embodiment that is suitable for packing existing color tables into a printer/copier 10. At step S310, a shared full size n-cube table is computed by averaging all of the original full size n-cube tables in a group. At step S312, a small size s-cube delta table is computed, where s=(integer) ((n+1)/2). For each s-cube grid, the corresponding averaged n-cube grid value of each ink, with the same coordinates as the s-cube grid, is subtracted from the original n-cube and value and assigned the delta value of the s-cube grid. The process then continues at step “E”.

Table II shows the results of an embodiment using the alternative method for existing tables from a group of processing conditions. The processing conditions included glossy paper 1, glossy paper 2, and the three corresponding quality modes. It will be appreciated from Table II that the average digital count difference before and after using the delta color table is about 0.5. This is considered an excellent result far better than any expectation one might get from an examination of prior art color tables.

TABLE II
Average digital count difference before and after using delta color tables

Average digital count difference
before and after using
delta color conversion lookup
tables: (1) original 17-cube,
and (2) derived 17-cube from
a 9-cube delta color
conversion lookup table per
mode/paper and a base of 17-
cube color conversion lookup
table shared by all of the
modes and glossy papers.

| Quality Mode | Glossy paper 1 | Glossy paper 2 |
|---|---|---|
| Quick | 0.57 | 0.52 |
| Normal | 0.50 | 0.53 |
| Best | 0.47 | 0.55 |
| Average | 0.51 | 0.53 |

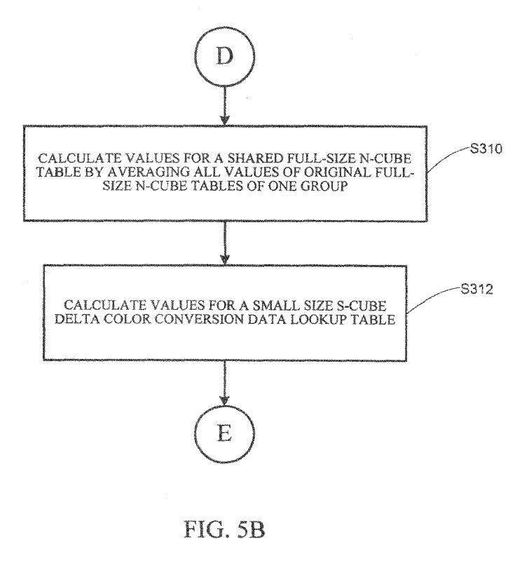

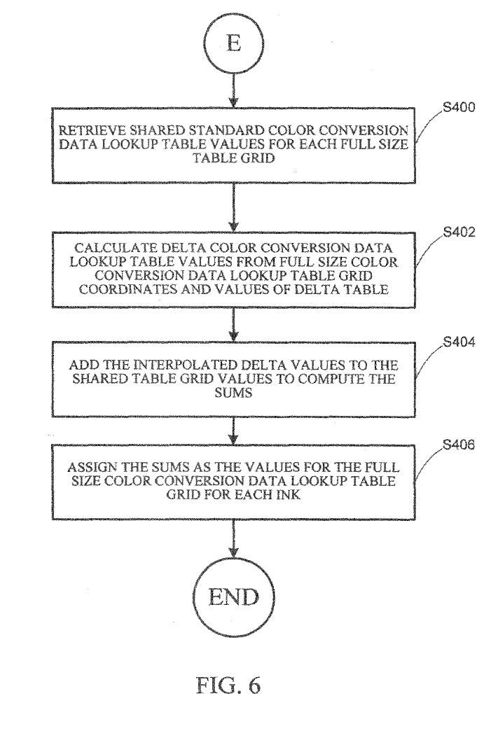

The full size shared standard color conversion data lookup table and individual small size delta color conversion lookup tables for each group of processing conditions are, in application, packed into the imaging apparatus 12. When a processing condition, e.g., the best printing mode for glossy paper 1 is selected, the system loads the full size shared standard color conversion data lookup table and the small size delta color conversion data lookup table for that condition into memory 36 from memory 23, 25, or 34, wherever they have been previously stored. A new full size standard color conversion data lookup table is then calculated in accord with the steps disclosed hereinbelow and discussed in connection with FIG. 6.

Turning now to FIG. 6, the process begins at step E from FIGS. 5A and 5B, and a linear interpolation on the small size delta color conversion data lookup table is performed using the full size table and coordinates at Step S400. At step S402, the delta color conversion data lookup table values are calculated from the full size color conversion data lookup table grid coordinates and the values from the small size delta table. At step 404, the interpolated delta value is added to the shared table grid value and the sum is assigned to a new full size table grid for each ink. At step S406, a dynamic full size new standard color conversion data lookup table 62 is created in the memory 36, as the controller 18 performs calculations on only the data from the table grids stored in the memory 36. It is to be appreciated that the disclosed method is significantly and unexpectedly faster than prior art methods, as the controller 18 does not perform calculations on each image pixel. After step S406, the method terminates at the “END” point.

Table III illustrates typical color table size differences before and after using an embodiment of the present invention. It will be noted that the method saves up to 80% of the space requirements when compared to prior art methods. The invention is particularly useful in systems where the embedded space is limited while a large number of paper types are required to be supported, such as in an AIO system.

TABLE III
Color table size difference between before and after using delta color
tables

| | Before using delta color conversion | | After using delta color | |
|---|---|---|---|---|
| | lookup table | | conversion lookup table | |
| | Glossy paper 1 | Glossy paper 2 (3 | Glossy paper 1 | Glossy paper 2 |
| | (3 regional | regional | (3 regional | (3 regional |
| Quality Mode | tables/mode) | tables/mode) | tables/mode) | tables/mode) |
| Quick | 3 * (17 * 17 * 17 * 3) | 3 * (17 * 17 * 17 * 3) | 3 * (9 * 9 * 9 * 3) | 3 * (9 * 9 * 9 * 3) |
| Normal | 3 * (17 * 17 * 17 * 3) | 3 * (17 * 17 * 17 * 3) | 3 * (9 * 9 * 9 * 3) | 3 * (9 * 9 * 9 * 3) |
| Best | 3 * (17 * 17 * 17 * 3) | 3 * (17 * 17 * 17 * 3) | 3 * (9 * 9 * 9 * 3) | 3 * (9 * 9 * 9 * 3) |

| | | |
|---|---|---|
| Common base | 0 | 17 * 17 * 17 * 3 |
| Total bytes | 265,302 | 54,105 |
| Saving space | 0 | 80% |

It will be appreciated that an alternate common base may be used, such as a group of plain paper simplex, plain paper duplex and coated paper simplex for two quality modes. In such an instance, a system in accord with the present invention will save about 80% in space requirements.

It will also be appreciated that the present invention provides a method of building space-efficient and cost-effective color conversion lookup tables by using small size delta color conversion data lookup tables and full size standard color conversion data lookup tables shared by all of a sub-set of processing conditions, all without degrading the color quality of the final image printed on media. It will also be appreciated that the present invention may be embodied in specific firmware in an ASIC, or in hardwired circuits.

The method of an embodiment of the present invention accommodates many different memory storage options, such as those indicated in step S106, in order to provide wide latitude in implementing the embodiment. For example, if the imaging object includes an associated memory, such as cartridge memory 23 or scanner memory 25, and the associated memory is of sufficient size to store the shared standard color conversion data lookup table 64 and the delta color conversion data lookup table 66, the shared standard color conversion data lookup table 64 and the delta color conversion data lookup table 66 may be stored in each imaging object 21 for use in performing color reproduction. The shared standard color conversion data lookup table 64 and the delta color conversion data lookup table 66 would automatically be retrieved by the imaging system 10 or the imaging apparatus 12 for use in generating the new standard color conversion data lookup table 62.

If a memory associated with the imaging object 21 is not large enough to store the shared standard color conversion data lookup table 64 and the delta color conversion data lookup table 66, they may be stored in one of the other mentioned memories. The shared standard color conversion data lookup table 64 and the delta color conversion data lookup table 66 may then be retrieved from such memory as needed.

In another implementation, the shared standard color conversion data lookup table 64 and the delta color conversion data lookup table 66 are stored in the offsite memory 34 of the offsite computer 32. In such a case, the imaging system 10 or the imaging apparatus 12 is used to access the offsite memory 34 via the network 28, such as the Internet, and to retrieve the shared standard color conversion data lookup table 64 and the delta color conversion data lookup table 66.

Persons of skill in the art will recognize many advantages of the present invention over known systems and methods. For example, a saving of about 800% in color table space requirements can be made, without degrading color quality. A large number of paper types for a given embedded space can also be supported. It will further be appreciated that color table errors often occur due to local color tweaks. The embodiment of the present invention reduces or eliminates color table errors due to local color tweaks that occur when a color table is created, as it can accommodate such local color tweaks in the stored data lookup tables. The embodiment also reproduces smoother color outputs. Other advantages will also be apparent to persons of ordinary skill in the art from the description contained hereinbefore.

The foregoing description of embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

1. In an imaging system having an imaging object and an initial full size color conversion data lookup table associated with processing conditions thereof, a method of calculating a full size color conversion data lookup table comprising the steps of:
determining the color linearity of said imaging object;
classifying said processing conditions of said imaging object into data groups based on said color linearity of said imaging object;
calculating a full size shared color conversion data lookup table common to said processing conditions for each of said data groups; and
calculating the differences between said initial full size color conversion data lookup table and said shared color conversion data lookup table to form a delta color conversion data lookup table.

2. The method of claim 1; and further comprising the steps of storing said full size shared color conversion data lookup table and said delta color conversion data lookup table in a memory.

3. The method of claim 2; and further comprising the steps of retrieving said full size shared color conversion data lookup table and said delta color conversion data lookup table from said memory.

4. The method of claim 3; and further comprising the step of calculating said full size color conversion data lookup table from said full size shared color conversion data lookup table and said delta color conversion data lookup table retrieved from said memory.

5. The method of claim 1; wherein said step of classifying said processing conditions includes the steps of sampling said imaging object for each processing condition to calculate a sampled cube data table; selecting a subset of said processing conditions and computing an averaged cube data table; subtracting said averaged cube data table from said sampled cube data table to calculate a delta cube data table; adding said delta cube data table to said averaged cube data table to calculate a derived cube data table; and calculating the average and maximum errors between said derived cube data table and said sampled cube data table.

6. The method of claim 1; wherein said system has a plurality of initial full size color conversion lookup tables associated with said processing conditions, and wherein said step of calculating said full size shared color conversion data lookup table includes the step of generating an averaged full size shared color conversion data lookup table by averaging all of said initial full size color conversion data lookup tables for each of said processing conditions.

7. The method of claim 6; and wherein said step of calculating said small size delta color conversion data table includes the step of subtracting said averaged fall size shared color conversion data lookup table from said initial full size color conversion data lookup tables.

8. The method of claim 1; wherein said step of calculating said full size shared color conversion data lookup table includes the step of identifying a most important quality mode within each group of processing conditions as said full size shared color conversion data lookup table.

9. The method of claim 8; wherein said step of calculating said small sized delta color conversion data lookup table includes the step of subtracting said full size shared color conversion data lookup table identified as said most important quality mode from said initial full size color conversion data lookup table.

10. A method of converting input color data to output color data in an imaging system having an imaging apparatus, a shared standard color conversion data lookup table and a delta color conversion data lookup table, comprising the steps of:
retrieving said shared standard color conversion data lookup table;
retrieving said delta color conversion data lookup table;
calculating a full size standard color conversion data lookup table from said shared standard color conversion data lookup table and said delta color conversion data lookup table;
calculating said output color data from said full size standard color conversion lookup table and said input color data.

11. The method of claim 10; wherein said step of classifying said input color data into groups includes the steps of sampling said input color data for each processing condition to calculate a sampled cube data table; selecting a subset of said processing conditions and computing an averaged cube data table; subtracting said averaged cube data table from said sampled cube data table to calculate a delta cube data table; adding said delta cube data table to said averaged cube data table to calculate a derived cube data table; and calculating the average and maximum errors between said derived cube data table and said sampled cube data table.

12. The method of claim 10; and further comprising the step of classifying said input color data into groups; and wherein said steps of retrieving said shared standard color conversion data lookup table and said delta color conversion data lookup table are performed according to said step of classifying said color data into said groups.

13. The method of claim 10; wherein said input color data is RGB input color data, and said output color data is CMYK output color data.

14. A system used in an imaging apparatus for receiving input color data, comprising:
a memory storing a shared standard color conversion data lookup table and a delta color conversion data lookup table associated with said imaging apparatus,
a first circuit for retrieving said shared standard color conversion data lookup table and said delta color conversion data lookup table;
a second circuit for calculating a standard color conversion data lookup table from said shared standard color conversion data lookup table and said delta color conversion data lookup table retrieved by said first circuit; and
a third circuit for applying said standard color conversion data lookup table to said input color data to generate output color data.

15. The system of claim 14; wherein said input color data have processing conditions associated therewith; and further comprising a fourth circuit for sampling said imaging object for each processing condition and calculating a sampled cube data table, a fifth circuit for sampling a subset of said processing conditions and computing an averaged cube data table therefrom, a sixth circuit for subtracting said averaged cube data table from said sampled cube data table and calculating a delta cube data table, a seventh circuit for adding said delta cube data table to said averaged cube data table and calculating a derived cube data table, and an eighth circuit for calculating the average and maximum errors between said derived cube data table and said sampled cube data table.

16. The system of claim 14; wherein said system has a plurality of initial full size color conversion lookup tables associated with said processing conditions, and wherein said full size shared color conversion data lookup table is stored in said memory by averaging said initial full size color conversion data lookup tables for each of said processing conditions to generate an averaged full size shared color conversion data lookup table.

17. The system of claim 16; and wherein said small size delta color conversion data lookup table is stored in said memory by subtracting said averaged full size shared color conversion data lookup table from said initial full size color conversion data lookup tables.

18. The system of claim 14; wherein said full size shared color conversion data lookup table is stored in said memory by identifying a most important quality mode within each group of processing conditions as said full size shared color conversion data lookup table.

19. The system of claim 18; wherein said small sized delta color conversion data lookup table is stored in said memory by subtracting said full size shared color conversion data lookup table identified as said most important quality mode from said initial full size color conversion data lookup table.

20. The system of claim 14; wherein said input color data is RGB input color data, and said output color data is CMYK output color data.
